(19) United States
(12) Patent Application Publication
(10) Pub. No.: US 2019/0061168 A1
(43) Pub. Date: Feb. 28, 2019

(54) Rotary Parallel Elastically Coupled Actuator

(71) Applicant: Flexiv Robotics Ltd., Santa Clara, CA (US)

(72) Inventors: Shiquan Wang, Foster City, CA (US); Xiyang Yeh, Santa Clara, CA (US)

(21) Appl. No.: 16/113,423

(22) Filed: Aug. 27, 2018

Related U.S. Application Data
(60) Provisional application No. 62/550,385, filed on Aug. 25, 2017.

(51) Int. Cl. B25J 13/08; F16H 35/00; G01L 3/10

(52) U.S. Cl. CPC B25J 13/085; G01L 3/101; F16H 35/008

(57) ABSTRACT

A torque-controllable rotary actuator is provided that includes a chassis, a first and second motor, a series elastic element, and an output link. The first motor, the series elastic element, and the second motor may all rotate around a common axis, and may all be located within the same module, which may be at the joint of a robotic arm. Certain embodiments may include a first gearbox, which may be coupled to the first motor. The torque-controllable rotary actuator may also contain a torque sensor that is configured to measure a torque applied to the rotary actuator. The torque-controllable rotary actuator may also include a second gearbox coupled directly to the second motor and/or a brake coupled directly to the first motor.

### PRIORITY CLAIM

This application claims the benefit of priority under 35 U.S.C. § 119(e) to U.S. Provisional Patent Application Ser. No. 62/550,385, entitled “ROTARY PARALLEL ELASTICALLY COUPLED ACTUATOR” and filed on Aug. 25, 2017, the disclosure of which is herein incorporated by reference in its entirety.

### BACKGROUND

Precise control of electromechanical systems is important in factory automation, logistics, supply chain operations, and many robotic applications. In multi-joint systems such as a robotic arm, performance is generally dependent on the actuation units at each of the joints. Such multi-joint units are conventionally operated via position control, in which the robot arms are trained to reproduce a specific range of motions and positions. Such training requires high precision because a difference of even a few millimeters may dramatically alter the results of certain operations, such as in assembling products. Also, position-controlled robotic arms are less able to adapt to uncertainty, such as uncertainty in the precise size or location of certain parts in an assembly operation. Computer vision may help address such uncertainty, but even computer vision solutions are imprecise. Lastly, position control is unable to precisely account for applied forces in applications such as polishing that depend on specific forces being applied.

Several emerging applications, including polishing, grinding, and certain assembling operations require careful control of contact forces from the robot arm and the ability for the robotic arm to adapt to uncertainty in part size and location. Such applications have greatly increased the need for torque-controllable actuators. A torque-controllable actuator is one that senses torques at the output and feeds the measurements back to a computer to realize active feedback control to ensure that the output torque is controlled to the desired value.

### SUMMARY

The present disclosure presents new and innovative systems for providing a torque-controllable rotary actuators. In one example, a torque-controllable rotary actuator for actuation in a multi-joint robotic system is provided comprising a chassis, a first motor, a series elastic element, a second motor, and an output link. The first motor, the series elastic element, and the second motor may rotate about a common axis and may all be contained within a module.

In another example, the torque-controllable rotary actuator may further comprise a torque sensor configured to measure a torque applied to the rotary actuator. In a further example, the torque sensor may include an elastic element and may be configured to measure the torque applied to the rotary actuator by measuring a deflection of the elastic element when the torque is applied. In a still further example, the torque sensor is configured to measure the torque applied to the rotary actuator by measuring a deflection of the series elastic element when the torque is applied. In yet another example, the torque sensor measures the deflection of the series elastic element using a Hall effect sensor.

In another example, the torque-controllable rotary actuator may further comprise a first gearbox coupled to the first motor. In a further example, the torque-controllable rotary actuator may further comprise a second gearbox coupled to the second motor. In a still further example, the torque-controllable rotary actuator may further comprise a brake coupled to the first motor.

In another example, the output link may be configured to rotate with respect to the chassis with a bearing. In a further example, the first gearbox may be coupled directly to the series elastic element. In a still further example, the first gearbox may be coupled directly to the torque sensor.

In another example, output link may be directly coupled to the series elastic element. In a further example, the output link is directly coupled to the torque sensor. In a still further example, the second motor is coupled to the chassis. In yet another example, the module is located at the joint of a robotic arm.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates block diagrams of two actuator designs according to exemplary embodiments of the present disclosure.

FIG. 2 illustrates an actuator system according to an exemplary embodiment of the present disclosure.

FIG. 3 illustrates an actuator system according to an exemplary embodiment of the present disclosure.

### DETAILED DESCRIPTION OF EXAMPLE EMBODIMENTS

Embodiments of the systems disclosed herein solve the problems above by, for example, designing torque-controllable actuators involves placing an elastic element at the actuator output and in series with the motor and an optional gearbox for purposes of measuring the torque applied by the actuator. In such implementations, torques can be computed by measuring the deflection of the elastic element and multiplying the deflection with a known and accurately-identified stiffness of the elastic element. This deflection is measured typically via position sensors placed at both ends of the elastic element.

In addition to providing benefits in torque sensing, placing an elastic element at the output of the actuator also improves the safety of the actuator by absorbing impact loads. Such an actuator, in the described configuration, is not without disadvantages. The series elastic element involved in such actuators may function as a low-pass filter that filters the sensing output. Because of this, the actuator's open loop frequency response is degraded, limiting the overall control performance of the robot. To compensate for this reduced bandwidth while preserving the actuator's safety, existing approaches involve incorporating a second smaller motor; such a motor may be incorporated at the other end of the elastic element.

One way of enhancing these designs is with a modularized actuator with high control bandwidth and safety characteristics. Unlike existing systems, coaxially coupling all the components in a compact form factor improves usability and manufacturability. The actuator can thus be easily incorporated into multi-joint robotic systems by installing it at the joint instead of relocating part of it to the base, which involves complex cable routing running from the base to the joint of interest.

In addition, by locating the complete actuator at each joint, control electronics can be placed right at the joint. By eliminating the need to use long wires to transmit critical sensor signals from the joint to the base, electronic noise can be significantly minimized. The actuator's modularity also benefits repair and maintenance efforts, as the complete package can be removed and replaced without having to disturb previous or subsequent joints.

The actuators described herein provide gains in safety, control performance, and modularity. The actuator is suitable for use in robotic arms and related systems, where single or multiple joints are needed. Actuating the joints on these systems may be performed to complete tasks such as picking up and positioning an object, applying forces and torques, and holding a fixture. In certain instances, these actuators may be marketable as individual components, or may be integrated into a larger electromechanical system.

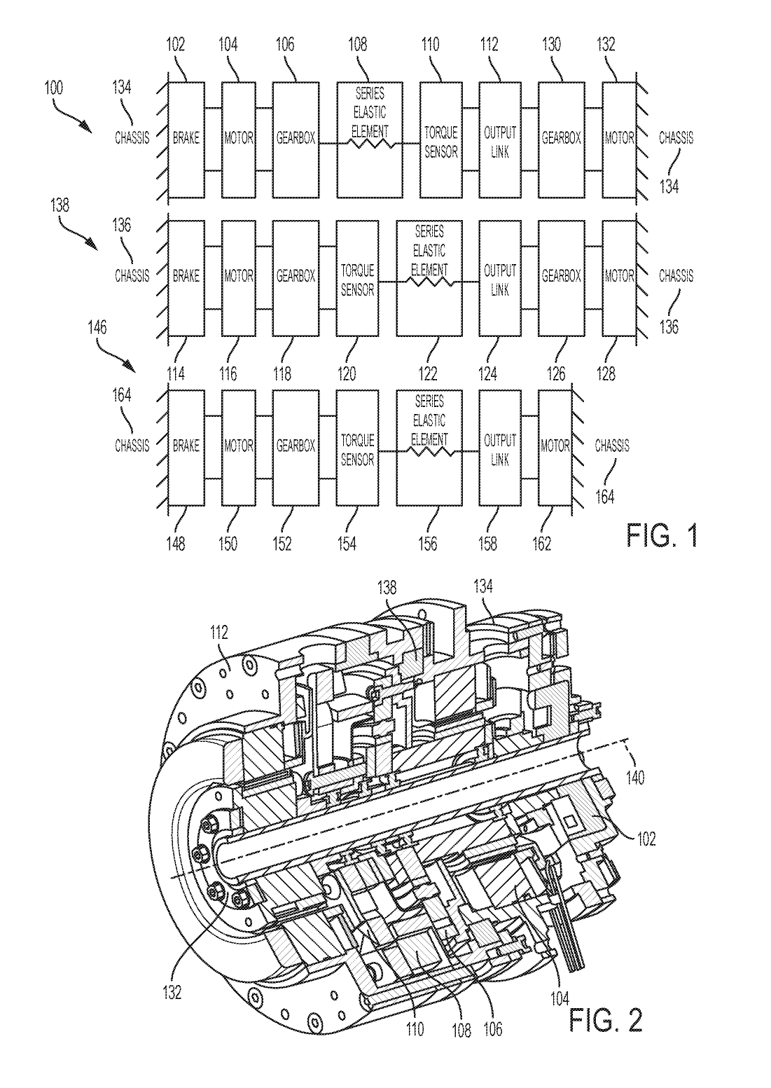

FIG. 1 depicts block diagrams of two actuator systems 100, 138 according to example embodiments of the present disclosure. In actuator system 100, a torque-controllable rotary actuator is provided for actuation in multi-joint robotic systems. The actuator system 100 includes a brake 102, a first motor 104, a gearbox 106 coupled to the first motor 104, a series elastic element 108, a torque sensor 110, a second motor 132, a gearbox 130 coupled to the second motor, and an output link 112 between the torque sensor 110 and the gearbox 130. Each of these components may be installed or positioned along a common axis defined by a common shaft. Also, the output link 112 can rotate with respect to the chassis with a bearing (e.g., the bearing 137 depicted in FIG. 2). In the actuator system 100, the brake 102 is connected between the housing or chassis 102 of the actuator system 100 and the input of the first motor 104. In other words, the output of the brake 102 is connected to the first motor 104. The output of the motor 104 is coupled rigidly to the input of the gearbox 106, which is then connected to a series elastic element 108. The output of the elastic element 108 is fixed to the input of torque sensor 110 and the output of the torque sensor 110 is then connected to the output link 112. In parallel to this assembly, another motor 128 is connected between the chassis 134 and another gearbox 130.

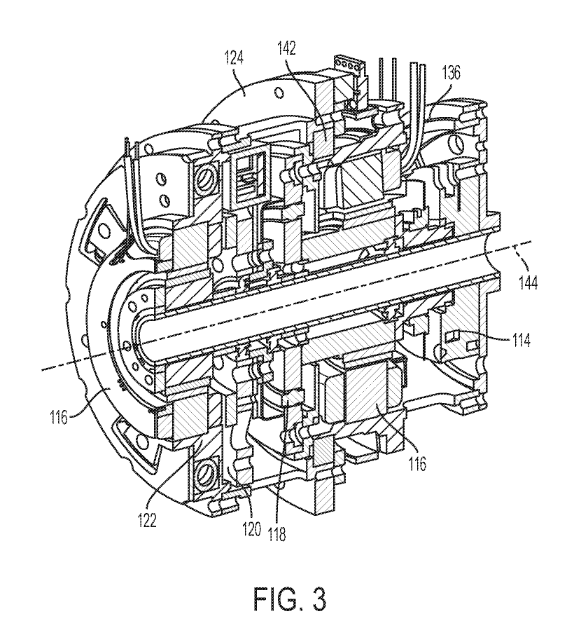

The second actuator system 138 includes similar components, such as a brake 114, a first motor 116 mounted about its axis, a gearbox 118 coupled to the first motor 116, a torque sensor 120, a series elastic element 122, an output link 124, a gearbox 126, and a motor 128. Each of these components may be installed or positioned along a common axis defined by a common shaft (e.g., the common axis 140 depicted in FIG. 2), and the output link 124 can rotate with respect to the chassis with a bearing (e.g., the bearing 142 depicted in FIG. 3), similar to the output link 116. In the actuator system 138, the brake 114 is connected to a motor 116, which is then connected to a gearbox 118. The output of the gearbox 118 is connected to the torque sensor 120 and the torque sensor 120 connects to a series elastic element 122. The actuator system 138 further includes the second motor 128, which is connected to the chassis 136 and the gearbox 126. The output link 124 is then connected between the series elastic element 122 and the gearbox 126. One notable difference between the two actuator systems 100, 138 is that the output of the gearbox 106 connects to the series elastic element 108 in the actuator system 100, whereas the output of the gearbox 118 connects to the torque sensor 120 in the actuator system 138.

In certain implementations, the actuator system 138 may be desirable because the torque sensor 120 is located near the gearbox 118 connected to the first motor 116. In such a configuration, the torque sensor 120 may be able to more accurately measure the torque being applied by the motor 116 through the gearbox 118. This configuration may also reduce lag in measuring the torque, as the series elastic element 122 may have a comparatively slow deflection response to applied torque. In other implementations, the actuator system 100 may be desirable for applications where the torque applied at the output link 112 needs to be measured. In such implementations, locating the torque sensor 110 near the output link 112 may enable quick and accurate measurement of the torque applied at the output link 112. Certain such applications may require that the series elastic element 108 between the gearbox 106 and the torque sensor 110 be stiff, so that the torque from the gearbox 106 is properly applied.

FIG. 1 also depicts the actuator system 146, which includes the brake 148 connected to the chassis 164, the motor 150 connected to the brake 148, and a gearbox 152 connected to the motor 150. The torque sensor 154 is depicted as connected to the gearbox 152, although it may alternatively be connected to the output link 158 for certain applications, as discussed above. The series elastic element 156 is connected between the torque sensor 154 and the output link 158. The second motor 162 is connected to the output link and the chassis 164. The actuator system 146 may be desirable for applications requiring a range of high and low torques applied at the output link 158. The actuator system 146 includes a direct drive motor 162 that is attached to the output link 158 without a gearbox. Such a direct drive motor 162 may be able to respond faster than the motor 150 with a gearbox 152, but may be limited to applying lower torques because it lacks a gearbox. The actuator system 146 also includes the motor 150 connected to a gearbox 152. The gearbox 152 may enable higher torque applications, but may slow the response time of the motor 150. In this way, the actuator system 146 includes two modalities for torque applications, each with characteristics optimized for different torque levels. The actuator system 146 further includes the series element 156 between both motors 150, 162 to limit to what extent the motors 150, 162 oppose one another's motion (i.e., by rotating in opposing directions).

The series elastic elements 108, 122, 156 may be any type of assembly that displays elastic behaviors like that of a spring while the torque sensor 110, 120, 154 may be designed based on Hall effect, strain gauges, capacitive, or optical technologies to measure the deflection of an elastic element within the torque sensor 110, 120, 154 and determine the applied torque based on the measured deflection. In certain embodiments, elastic elements 108, 122, 156 may be designed with stiffness values much lower than that of the elastic elements within the torque sensors 110, 120, 154 to preserve the softness of the actuator systems 100, 138, 146 against impact loads. The torque sensor 110, 120, 154 may also be configured to measure the deflection of the series elastic elements 108, 122, 156 and determine an applied torque based on the measured deflection. The gearboxes 106, 130, 118, 126, 152 may be selected to amplify the torques from the motors 104, 132, 116, 128, 150, 162. Certain embodiments may remove the gearboxes 106, 130, 118, 126, 152 from the design when the torque outputs from the motors 104, 132, 116, 128, 150, 162 are sufficient, or where multiple torque application capabilities are required. The motors 104, 132, 116, 128, 150, 162 may be selected as any motor capable of maintaining a coaxial orientation with the other components in the actuator system 100, 138, 146. For example, the motors 104, 132, 116, 128, 150, 162 may be implemented as frameless motors. In other implementations, the motors 104, 132, 116, 128, 150, 162 may be implemented as motors mounted on the outside of the module, although such implementations may add cost and complexity to the design.

Additional rotary position sensors (not pictured) may be incorporated into the actuator systems 100, 138, 146 to measure additional rotary displacements within the system 100, 138, 146. One absolute or incremental position sensor may be placed near the first motor 104, 116, 150 to measure an angle of rotation for the motor 104, 116, 150 with respect to the chassis 134, 136, 164. Another absolute or incremental position sensor may be placed between the output link 112, 124, 158 and the chassis 134, 136, 164.

Additional embodiments on the designs of the actuator systems 100, 138 may be seen in FIGS. 2 and 3, which depict perspective views of exemplary actuator systems 100 and 138, respectively, according to an exemplary embodiment of the present disclosure.

In certain embodiments of the actuator system 100, a compliant transmission may be selected to act as both the gearbox 106 and the elastic element 108, and a separate and much stiffer torque sensor 110 may then be attached to the output link 112 for torque sensing. However, in such embodiments, the compliant transmission may have to include a pair of preloaded springs attached to cables. Due to the large travels of these springs and the distant placement of the motors, a large packaging volume for the actuator system 100 may result, which can be prohibitive when it comes to fitting the actuator 100 on the joints of a multi-joint robotic system. As a result, this particular embodiment of the actuator system 100 may only be suited for use in a single joint robotic system.

In some embodiments of the actuator system 100, 138, 146 further reductions in packaging size may be achieved by relocating the series elastic element 108, 122, 156 and the first motor 104, 116, 150 to the base of a robotic system joint. In such embodiments, the actuator system 100, 138, 146 and the base assembly of the robot may be coupled with cable-drives. The series elastic element 108, 122, 156 may also be implemented as a custom machined spring. Further, instead of using a separate torque sensor 110, 120, 154 torque measurements may be derived from the deflection of the elastic element 108, 122, 156 using sensors (e.g., Hall-effect sensors, optical sensors, capacitive sensors). Using such designs for the actuator systems may allow for actuator systems 100, 138, 156 compact enough for use in two- and three-joint robotic systems.

However, although these designs improve the possibility of creating multi-joint robotic systems, the cable drives used in certain embodiments may not be not scalable to larger number of joints, since the associated cables would have to be routed with multiple idler pulleys from the base of the robotic system to the final joint of the robotic system via connecting links. Furthermore, since these embodiments are used with low number of joints, brakes 102, 114, 147 may not be integrated to hold the system in place against gravity when power is removed. Thus, depending on the application, it may be the case that only low-power systems may be created using such embodiments.

To achieve a modularized design and thus improve ease of integration and scalability in multi-joint robot manipulator designs, the actuator systems 100, 138, 146 feature several differentiating design features to optimize for compactness. First, the motors are both placed at separate ends of the actuator system 100, 138, 146 near the joints, which optimizes torque transmission to the joints. Secondly, the disclosed designs arrange all the components to rotate via a common axis 140, 144 to minimize radial size of the assembly. Certain embodiments also include a torque sensor dedicated to measuring the torque applied, which eliminates the need to identify the stiffness values of series elastic element for torque measurements.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A torque-controllable rotary actuator for actuation in a multi-joint robotic system, comprising:
a chassis;
a first motor;
a series elastic element;
a second motor; and
an output link,
wherein the first motor, the series elastic element, and the second motor rotate about a common axis;
wherein the chassis, the first motor, the series elastic element, the second motor, and the output link are all within a module.

2. The torque-controllable rotary actuator of claim 1, further comprising:
a torque sensor configured to measure a torque applied to the rotary actuator.

3. The torque-controllable rotary actuator of claim 2, wherein the torque sensor includes an elastic element and wherein the torque sensor is configured to measure the torque applied to the rotary actuator by measuring a deflection of the elastic element when the torque is applied.

4. The torque-controllable rotary actuator of claim 2, wherein the torque sensor is configured to measure the torque applied to the rotary actuator by measuring a deflection of the series elastic element when the torque is applied.

5. The torque-controllable rotary actuator of claim 4, wherein the torque sensor measures the deflection of the series elastic element using a Hall effect sensor.

6. The torque-controllable rotary actuator of claim 1, further comprising:
a first gearbox coupled to the first motor.

7. The torque-controllable rotary actuator of claim 1, further comprising:
a second gearbox coupled to the second motor.

8. The torque-controllable rotary actuator of claim 1, further comprising:
a brake coupled to the first motor.

9. The torque-controllable rotary actuator of claim 1, wherein the output link is configured to rotate with respect to the chassis with a bearing.

10. The torque-controllable rotary actuator of claim 6, wherein the first gearbox is coupled directly to the series elastic element.

11. The torque-controllable rotary actuator of claim 6, wherein the first gearbox is coupled directly to the torque sensor.

12. The torque-controllable rotary actuator of claim 1, wherein the output link is directly coupled to the series elastic element.

13. The torque-controllable rotary actuator of claim 2, wherein the output link is directly coupled to the torque sensor.

14. The torque-controllable rotary actuator of claim 1, wherein the second motor is coupled to the chassis.

15. The torque-controllable rotary actuator of claim 1, wherein the module is located at the joint of a robotic arm.
